(19) United States
(12) Patent Application Publication
(10) Pub. No.: US 2005/0012963 A1
(43) Pub. Date: Jan. 20, 2005

(54) Image processing apparatus, image processing method, and computer product

(76) Inventor: Maiko Yamads, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/893,482

(22) Filed: Jul. 16, 2004

(30) Foreign Application Priority Data
Jul. 16, 2003 (JP) 2003-197815
Apr. 20, 2004 (JP) 2004-124316

(51) Int. Cl. H04N 1/58; H04N 1/60; H04N 1/64

(52) U.S. Cl. 358/2.1; 358/523; 358/426.04; 358/3.24; 358/539; 358/3.26

(57) ABSTRACT

An image processing apparatus includes a compressing unit that compresses image data input by an input unit at a desired compression ratio to generate compressed image data, a storage unit that stores the compressed image data, and a control unit that reads out the compressed image data stored in the storage unit and determines whether image correction according to color distribution of the image data should be performed based on the compression ratio and a type of the image data.

The present application claims priority to the corresponding Japanese Application Nos. 2003-197815, filed on Jul. 16, 2003 and 2004-124316, filed on Apr. 20, 2004, the entire contents of which are hereby incorporated by reference.

### BACKGROUND OF THE INVENTION

1. Field of the Invention

The present invention relates to an image processing apparatus and an image processing method, which compress image data and store the compressed image data, and perform image correction according to a compression ratio and the type of the image data when outputting the image data, an image processing program according to the method, and a recording medium having the image processing program.

2. Description of the Related Art

Image data is generally recorded in a compressed and encoded form, because image data contains vast amount of data. A typical image compression coding method is the Joint Photographic Experts Group (JPEG) method that uses transform coding. According to the JPEG system, orthogonal transform, such as discrete cosine transform (DCT), is performed to eliminate the correlation between adjoining pixels that an image inherently has, then acquired transform coefficients are quantized and variable length coding, such as Huffman coding, is adapted.

To favorably output an image based on image data to a printer or a display, color processing, such as color correction or color conversion, have to be performed.

With regard to this process, a technique capable of improving the quality of an output image by creating the luminance histogram of image data and by using a Look Up Table (LUT) for Red-Green-Blue (RGB) to Cyan-Magenta-Yellow-Black (CMYK) conversion has been utilized. However, RGB to CMYK conversion using an equal LUT that does not take the compression ratio of input image data into consideration deteriorates an image due to reduction in image contrast and a change in color tone when the compression ratio is high.

As a solution to the problem, there is a technique that prepares different LUTs according to different compression ratios and changes an LUT in use according to the actual compression ratio (see, for example, Japanese Patent Application Laid-Open No. 2001-211336).

In case of a natural image, when input image data itself is poor due to the image pickup conditions or the like, the image data is printed with a high fidelity so that the output image may not be of a good quality.

Another technique is disclosed, which corrects the color balance, contrast, and chroma well by performing image correction on a natural image according to the color distribution of an input image (see, for example, Japanese Patent Application Laid-Open No. 2000-11152).

However, the former technique disclosed in Japanese Patent Application Laid-Open No. 2001-211336 determines an image correction pattern based only on the compression ratio and does not discriminate the type of an image, such as a natural image, a character or a dot image. In general, deterioration of the image quality differs significantly according to the type of an input image and the compression ratio. If the type of an image is not taken into consideration, therefore, the quality of an output image becomes poor.

The latter technique disclosed in Japanese Patent Application Laid-Open No. 2000-11152, which performs image correction only on a natural image, does not take the compression ratio into consideration. Therefore, the technique also performs image correction on images compressed at a high compression ratio, from which a significant effect cannot be expected, thereby resulting in a poor processing efficiency.

### SUMMARY OF THE INVENTION

An image processing apparatus, image processing method, and computer product are described. In one embodiment, the image processing apparatus comprises a compressing unit that compresses image data input by an input unit at a desired compression ratio to generate compressed image data; a storage unit that stores the compressed image data; and a control unit that reads out the compressed image data stored in the storage unit and determines whether image correction according to color distribution of the image data should be performed based on the compression ratio and a type of the image data.

### BRIEF DESCRIPTION OF THE DRAWINGS

FIG. 1 is a block diagram of an image processing apparatus according to one embodiment of the present invention;

FIGS. 2A to 2C depict a color solid axis of an image in a luminance color difference space;

FIG. 3 depicts a conversion of a luminance component;

FIGS. 4A to 4D depict over-exposed or under-exposed states on a plane having chroma and luminance;

FIG. 5 is a diagram of an operation panel of the image processing apparatus;

FIG. 6 is a display example of the operation panel;

FIG. 7 is a cross-sectional diagram of the configuration of a laser beam printer;

FIG. 8 is a flowchart of one embodiment of an image processing method of the present invention;

FIG. 9 is a flowchart of another embodiment of an image processing method of the present invention; and

FIG. 10 is a flowchart of yet another embodiment of an image processing method of the present invention.

### DETAILED DESCRIPTION

In one embodiment of the present invention, the problems set forth above in the conventional technology are solved.

The image processing apparatus according to one embodiment of the present invention includes a compressing unit that compresses image data input by an input unit at a desired compression ratio to generate compressed image data, a storage unit that stores the compressed image data, and a control unit that reads out the compressed image data stored in the storage unit and determines whether image correction according to color distribution of the image data should be performed based on the compression ratio and a type of the image data.

The image processing method according to another embodiment of the present invention includes compressing image data input by an input unit at a desired compression ratio to generate compressed image data, storing the compressed image data, reading out the compressed image data stored in the storage unit, and determining whether image correction according to color distribution of the image data should be performed based on the compression ratio and a type of the image data.

The computer readable recording medium according to still another embodiment of the present invention stores a computer program that realizes the image processing method according to the above embodiment on a computer.

The other embodiments, features, and advantages of the present invention are specifically set forth in or will become apparent from the following detailed description of the invention when read in conjunction with the accompanying drawings.

Exemplary embodiments of an image processing apparatus, image processing method, and computer product according to one embodiment of the present invention are described in detail with reference to the accompanying drawings.

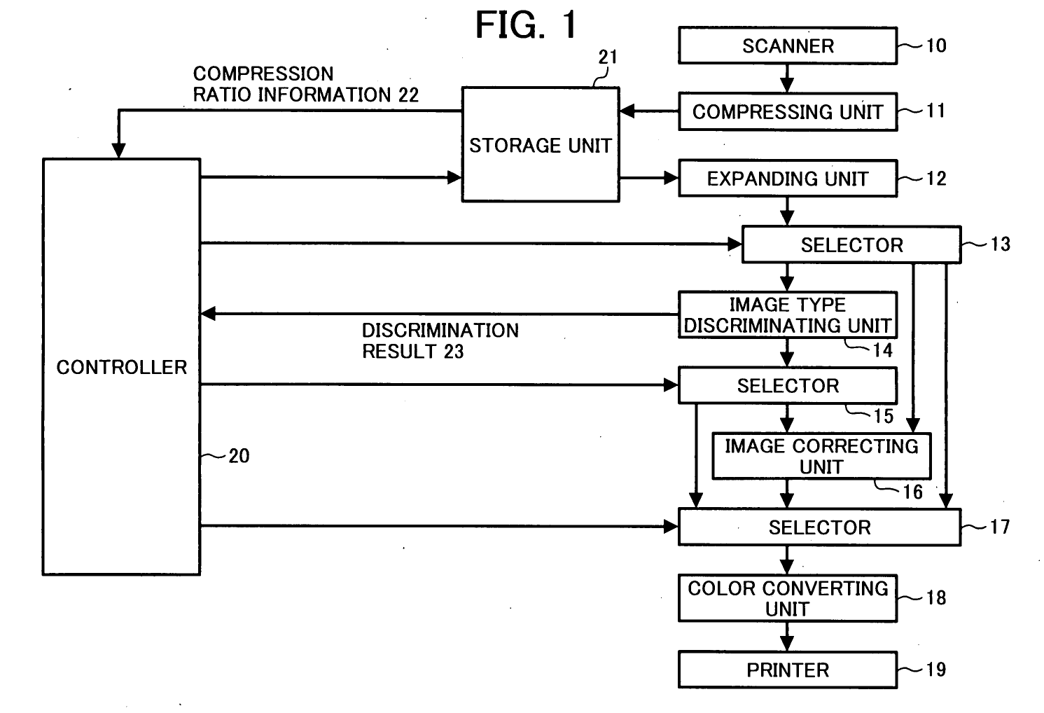

FIG. 1 is a block diagram of an image processing apparatus (color image copying machine) according to one embodiment of the present invention.

The image processing apparatus includes a scanner (input unit) 10, a compressing unit 11, an expanding unit 12, an image type discriminating unit 14, a controller (control unit) 20, an image correcting unit 16, a color converting unit 18, a printer 19, a storage unit (image data storage unit) 21, and selectors 13, 15, and 17.

The scanner 10 is one type of input unit for image data, and has a function of scanning a document to acquire its image data. The scanner 10 may be replaced with a unit that acquires print information, such as character codes, or image data, which is input from outside.

The compressing unit 11 is capable of compressing RGB signals of image data from the scanner 10 by a desired compression ratio R set externally (e.g., input on an operation panel to be discussed later) by using a data compression technique to store image data efficiently. One data compression technique available is compression using, for example, the JPEG compression technology.

Specifically, image data (for one screen) from the scanner 10 is segmented into unit areas A of a predetermined number of pixels (e.g., 16 pixels×16 pixels), and image data for each area is subjected to DCT conversion to yield DCT coefficients (256 frequency components or 16 components horizontal×16 components vertical). The DC component and AC component of the DCT coefficient are then entropy-coded according to the compression ratio R, after which the entropy codes are multiplexed with information in a quantization table and an entropy coding table, used in all the processes taken up to the entropy coding, information on the pixel size of an original image and added information or the like for creating a file, yielding compressed image data (JPEG image data). The compressed image data is then stored in the storage unit 21. Information 22 on the compression ratio R corresponding to the compressed image data (compression ratio information) is also stored in the storage unit 21.

The expanding unit 12 has a capability of acquiring plural pieces of compressed image data (JPEG image data) from the storage unit 21 and generating one screen of restored image data. That is, the expanding unit 12 acquires restored image data through quite opposite procedures to the procedures of generating compressed image data from original image data, which are performed in the compressing unit 11. The restored image data acquired is sent to the selector 13.

The selector 13 has a capability of separating the restored image data to image data for each area A of the predetermined number of pixels (segmented image data) and sending the segmented image data to one of the image type discriminating unit 14, the image correcting unit 16, and the selector 17 in response to an instruction from the controller 20 based on the compression ratio information 22.

The image type discriminating unit 14 is capable of discriminating what type of image the segmented image data sent from the selector 13 is. A well-known technique can be used as the method of discriminating the image type. For example, the discrimination method disclosed in Japanese Patent Application Laid-Open No. 2000-295468 can be used. Specifically, after the segmented image data is separated into plural pieces of binary image data according to the density difference of peripheral pixels, the chroma, etc., the binary image data is segmented into regions in each of which characters, figures or the like are linked physically or logically, each segment region is extracted, and the amounts of the characteristics of the segment region, such as the position, the size, the shape, the structure, and the density distribution, are measured. A well-known technique, such as the one disclosed in Japanese Patent Application Laid-Open No. H11-252360, can be used as a specific method of separating segmented image data into plural pieces of binary image data. In this case, seven types of binary segmented image data, namely, a character image, a half tone image, a background image, a dot image, a color image, a gray image, and a black image, are generated.

The characteristic amounts of the plural pieces of binary segmented image data are then integrated according to given rules, the attribute (character, dot, photograph or the like) for each pixel of segmented image data is determined, yielding pixel attribute data. The type of an image (character, a dot image, a natural image) is then discriminated based on the pixel attribute data.

Specifically, when there is a character region or a dot region as pixel attribute data of target segmented image data, the image type is discriminated as a character/dot image. When there is neither a character region nor a dot region as pixel attribute data, the image type is discriminated as a natural image. The “natural image” is, for example, the image of a target picked up by an image sensing device, such as a digital camera.

The selector 15 has a capability of sending the segmented image data to the image correcting unit 16 or the selector 17 in response to an instruction from the controller 20 based on discrimination result information 23 about the image type.

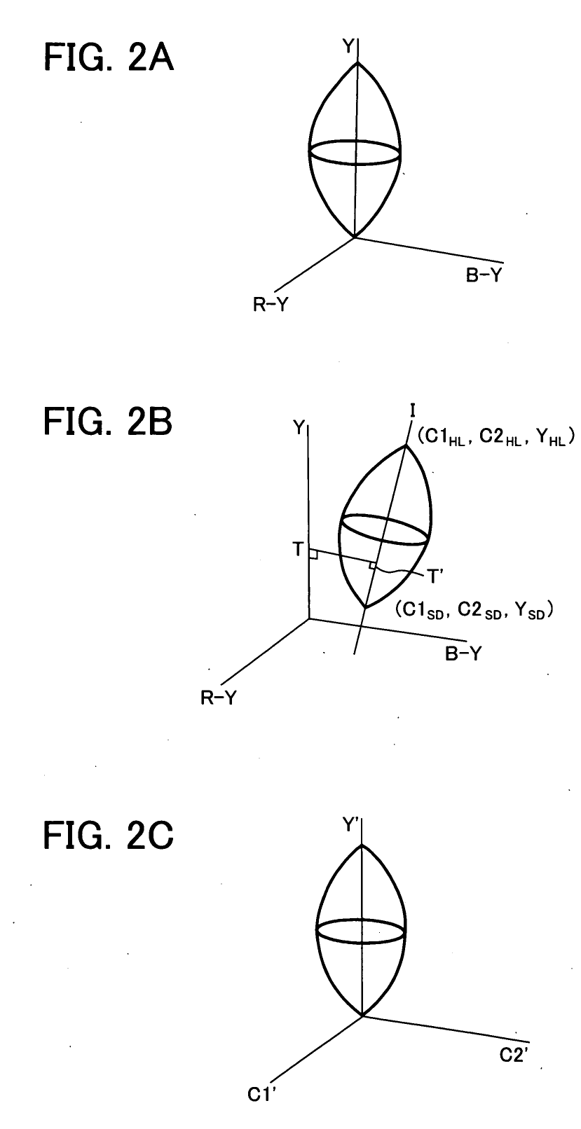

The image correcting unit 16 creates the luminance histogram of the segmented image data, sets conditions for image correction according to the color distribution of the segmented image data based on the histogram and the compression ratio R, and executes color balance correction, contrast correction and chroma correction as image correction. The details of those processes will be described below referring to FIGS. 2 to 4.

In performing color balance correction, first, a highlight point and a shadow point in segmented image data are determined. At that time, for example, an accumulated frequency histogram on a brightness signal weighed by individual color signals R, G, and B of the input signal is created, and the upper limit of the brightness signal corresponding to a predetermined accumulated frequency set beforehand in the accumulated frequency histogram is determined as a highlight point and the lower limit is determined as a shadow point.

Color difference signals (C1, C2) of a pixel having the brightness of the highlight point and shadow point of the image are then acquired from
C1=R−Y
C2=B−Y
where R is a red signal, B is a blue signal, and Y is a luminance signal, and let the average values be a color difference amount (C1(HL), C2(HL)) of the highlight point, and a color difference amount (C1(SD), C2(SD)) of the shadow point.

A color solid axis (achromatic color axis) I of the input segmented image data can be predicted from the color difference amount of the highlight point and the color difference amount of the shadow point, as shown in FIG. 2B.

The color solid axis I of a color solid of an ideal image with no color balance shifted matches with a luminance axis Y, as shown in FIG. 2A. Therefore, color balance correction is performed by acquiring a rotation matrix to convert the color solid axis I (defined by the highlight point and the shadow point) of the input object image and the amount of parallel movement and correcting the input segmented image data using the rotation matrix and the amount of parallel movement.

Once the rotational axis and its angle are decided, the rotation matrix can be obtained easily. Therefore, points of each pixel (C1, C2, Y) in the input image data in FIG. 2B are converted in the three-dimensional space to points (C1′, C2′, Y′) on the coordinate axis as in FIG. 2C. The color balance of the image is corrected in the three-dimensional space in this way.

In the contrast correction and chroma correction, over exposure or under exposure of the segmented image data are determined easily and gamma correction is performed on the luminance signal accordingly.

The contrast correction adjusts the luminance of the shadow point to “0” or a value closer to “0” (e.g., “10”) and the luminance of the highlight point to “255” or a value closer to “255” (e.g., “245”) through gamma correction according to the exposure state of the segmented image data. The following describes one example of easily determining over exposure or under exposure of the segmented image data and gamma correction according to the exposure is applied.

First, the point that makes the shortest distance to the luminance axis Y is acquired from a point on the color solid axis of segmented image data, i.e., a point T is acquired from a point T′ in FIG. 2B. This point can be obtained easily from a geometric relationship.

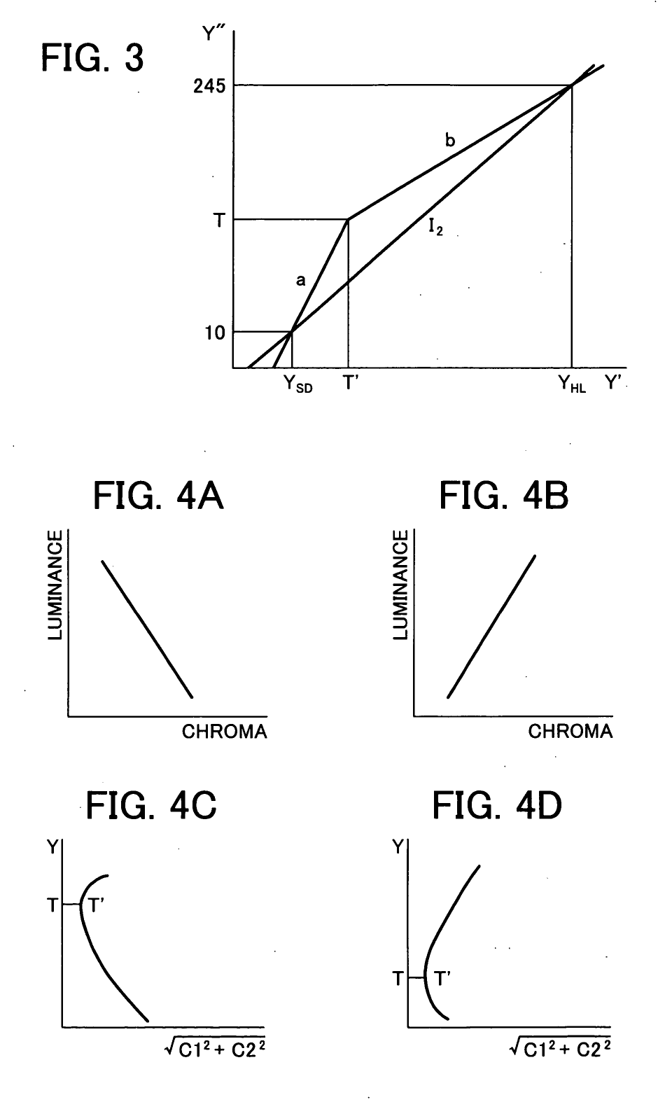

The contrast is then adjusted so that the point T′ becomes the point T. That is, when a value on a luminance axis Y′ is smaller than T′ with the coordinates (T, T′) as an inflection point as shown in FIG. 3, correction to convert the value to a value on a luminance axis Y″ by a line a is performed, whereas when the value is greater than T′, correction to convert the value to a value on the luminance axis Y″ by a line b is performed. Accordingly, the luminance Y_{SD} of the shadow point is adjusted to “10” and the luminance Y_{HL} of the highlight point is adjusted to “245.” When the color solid axis of the segmented image data becomes parallel to the luminance axis or in a similar case, correction to convert the target value by a line I₂ is performed.

The effect of correction with T, T′ is effective particularly for an image that is over-exposed or under-exposed. The over-exposed state is brought about when the general view is attracted to a bright point such as the sky. At this time, an input device like a digital camera executes high luminance color suppression to lower the chroma of a high-luminance portion.

That is, when the color solid axis of the image is considered as a two-dimensional plane having chroma and luminance as axes as shown in FIG. 4A, a portion closest to achromatic color appears at a high-luminance portion.

Low-luminance color suppression is applied to an image in the under-exposed state, resulting in a state as shown in FIG. 4B. It is therefore possible to easily determine whether the image is over-exposed state or under-exposed state based on the values of T and T′.

When the luminance axis of the color solid of an actual image is considered as a luminance-chroma plane, the state becomes as shown in FIG. 4C for an over-exposed image. On the other hand, the state becomes as shown in FIG. 4D for an under-exposed image.

If the actual color solid is shifted from the color solid in the proper state (ideal state) due to some image-pickup conditions or the influence at the input time (at the time of A/D conversion), the position at the coordinates (T, T′) in FIG. 3 is considered as a location with the smallest deviation. Accordingly, the adequate gray or overall brightness correction is performed easily by returning the actual color solid to the ideal color solid.

Chroma correction can be performed very easily. To increase chroma by 20%, for example, chroma correction can be executed by performing the following processes
C1″=1.2×C1′
C2″=1.2×C2′
because chroma is defined by
(Chroma)=(C1²+C2²)^{1/2}

The degree of chroma adjustment may be determined based on a user's instruction set on the user interface of a printer driver.

As described above, as image correction is performed on the luminance color difference space, a correction parameter to be used in the image correction is expressed in the form of a three-dimensional LUT that is created by a parameter 1 for converting an RGB signal of input segmented image data to luminance color difference signals, a parameter 2 for performing color balance correction, contrast correction, and chroma correction on the luminance color difference space and a parameter 3 for converting a luminance color difference signal to an RGB signal.

The parameter 2 is comprised of the rotation matrix explained in the description of color balance correction, the table for converting the luminance component as shown in FIG. 3 that has been explained in the description of contrast correction and a coefficient for correcting the color difference signal undergone color balance correction explained in the description of chroma correction.

The rotation matrix and the table for converting the luminance component are acquired based on the histogram of the luminance component of a target image to be corrected or an object image.

The selector 17 has a capability of sending segmented image data sent from the selector 13 and the selector 15, and segmented image data undergone image correction in the image correcting unit 16, as one screen of image data, to the color converting unit 18.

The color converting unit 18 has a capability of performing RGB to CMYK color conversion on the image data sent from the selector 17 by a well-known technique and sending the resultant image data as image data of a CMYK signal to the printer 19.

The printer 19 is capable of outputting image data of the CMYK signal sent from the color converting unit 18 by a predetermined system.

The controller 20 is capable of controlling the selector 13 based on the compression ratio information 22 stored in the storage unit 21, controlling the selector 15 based on the discrimination result information 23 in the image type discriminating unit 14 and controlling the selector 17 in such a way that different pieces of segmented image data are collected as one screen of image data.

The storage unit 21 is capable of storing compressed image data compressed by the compressing unit 11 and the compression ratio information 22 corresponding to the compressed image data, and sending the compressed image data to the expanding unit 12 and the compression ratio information 22 to the controller 20, as need.

A description will be given of the flow from the reading of image data by the scanner 10 to the outputting of image data from the printer 19 in the image processing apparatus.

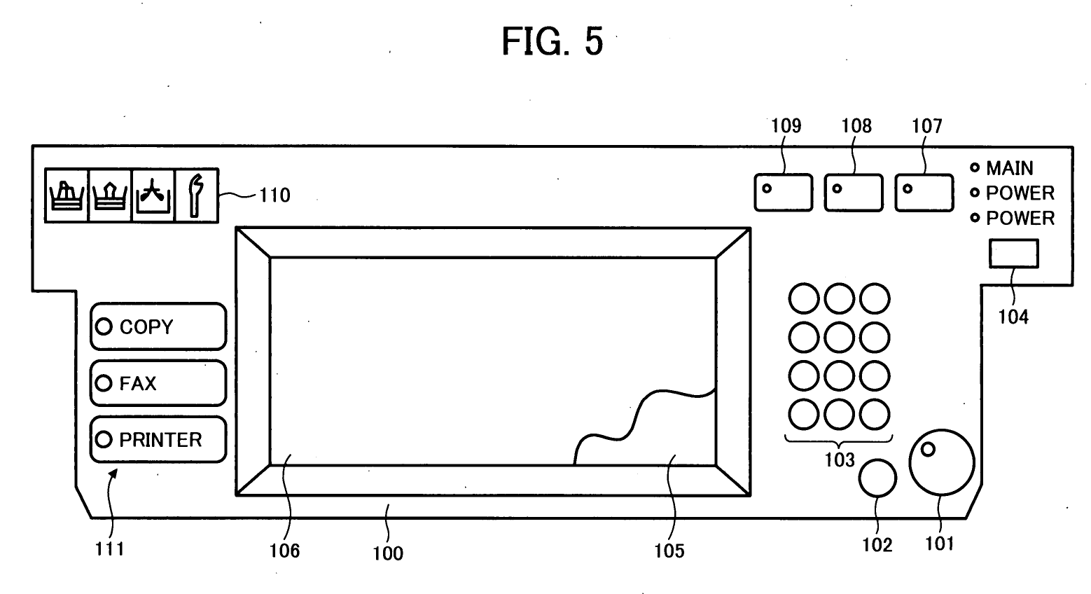

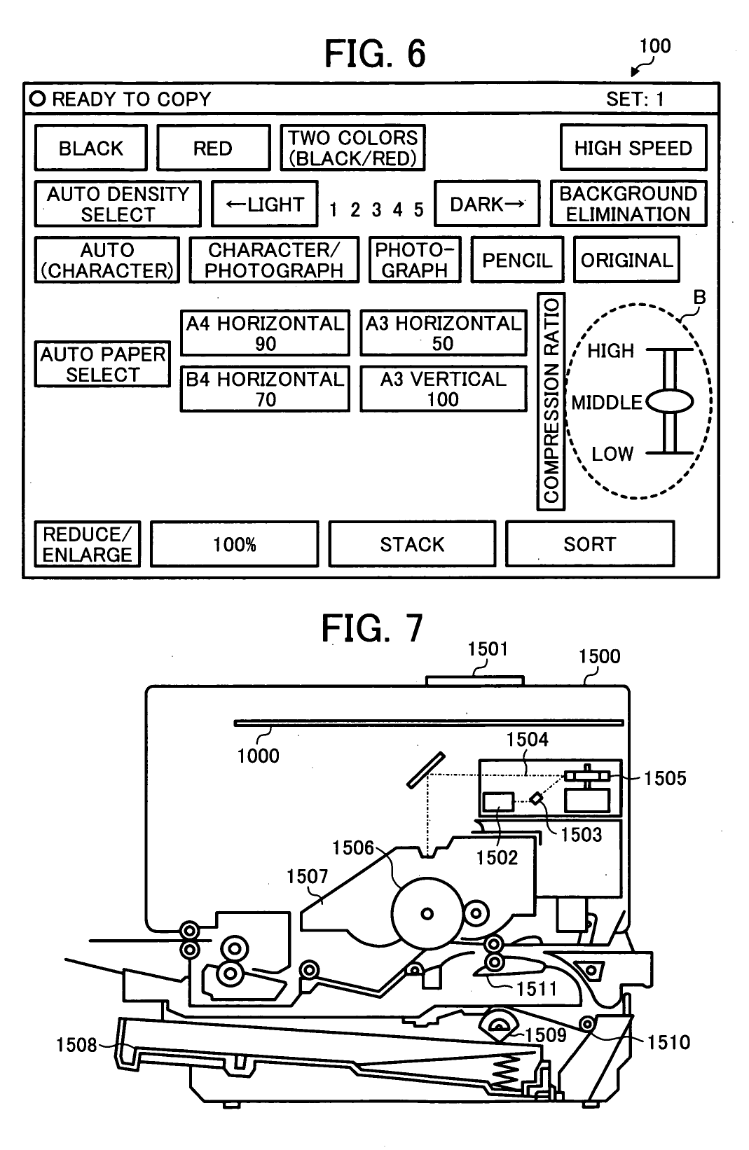

Before image data is read by the scanner 10, a mode where the compression ratio of the image data is to be compressed is preset, e.g., one of a low image quality (high compression ratio of 1/12), a standard image quality (intermediate compression ratio of 1/8), and high image quality (low compression ratio of 1/4), is selected. The selection should be set by the user on the operation panel provided on the image processing apparatus. An example of the selection is shown in FIGS. 5 and 6.

FIG. 5 is a diagram of the operation panel of the image processing apparatus such as a copying machine or a facsimile. A liquid crystal display (LCD) 105 and a touch panel 106 are mounted on an operation panel 100 so that touching soft keys on the screen can facilitate complicated function setting. A digital multifunction product may have a facsimile function and a printer function in addition to a copy function, and is provided with an application change key 111 for changing the applications from one to another. Common keys to the individual applications include a start key 101, numeric keys 103 to designate the number of copies or the transmission destination, a clear/stop key 102 to clear a number or stop a copy operation or the like, an interruption key 107 to enable an interruption copy, a preheat key 108 to go/return to a preheat mode, and a program key 109 to hold/invoke an established copy mode or the like. Further, hard keys such as a power key 104 for to/return to a standby mode of minimum power are provided. The operation panel 100 is also provided with an alert display unit 110 that illuminates various kinds of alert displays, such as “toner-out,” with a Light emitting diode (LED).

FIG. 6 is an example of selecting the mode for the compression ratio on the operation panel 100.

At the time of printing, the compression ratio mode (high compression ratio, intermediate compression ratio, low compression ratio, etc.) is displayed on the screen of the operation panel 100, so that as a user selects the desired compression ratio mode by touching the operation panel 100, the compression ratio R can be set. The selected compression ratio mode is sent as the compression ratio information 22 to the storage unit 21.

The mode selection for the compression ratio is not limited to the method but may be selected by the user through a menu or the like on the screen of a personal computer (PC) or set according to the performance of the printer. The compression ratios 1/12, 1/8, and 1/4 are just examples and may be set to different ones as needed.

The RGB signal of the image data input by the scanner 10 is then read by the compressing unit 11 and image data is compressed at the desired compression ratio R externally set, yielding compressed image data. The compressed image data and the compression ratio information 22 (the compression ratio R) associated with that compressed image data are stored in the storage unit 21.

At the time image data is compressed, one screen of image data is segmented into given areas (e.g., 16 pixels×16 pixels) as described above, each of which is subjected to a DCT to be compressed image data.

The compressed image data stored in the storage unit 21 is then sent to the expanding unit 12 at a predetermined timing, where the compressed image data is expanded to be restored into one screen of image data. At the same time, the compression ratio information 22 corresponding to the image data is sent to the controller 20. The image data is then sent to the selector 13.

Based on the received compression ratio information 22, the controller 20 determines whether the image data sent to the selector 13 should be separated into image data (segmented image data) for each area A of the predetermined number of pixels and the type of the image should be discriminated for each segmented image data.

When determining that the image type should be discriminated, the controller 20 sends the selector 13 an instruction to send the segmented image data to the image type discriminating unit 14, and the selector 13 sends the segmented image data to the image type discriminating unit 14 based on the instruction.

When determining that the image type is not discriminated, the controller 20 sends the selector 13 an instruction to send the segmented image data to the image correcting unit 16 or the selector 17, and the selector 13 sends the segmented image data to the image correcting unit 16 or the selector 17 based on the instruction.

When the segmented image data is sent to the image type discriminating unit 14, the unit 14 acquires pixel attribute data from the characteristic amounts of plural pieces of binary segmented image data, which are measured from the segmented image data as mentioned above, and discriminates the image type (character/dot image, natural image) based on the pixel attribute data. The discrimination result information 23 is then sent to the controller 20 and the segmented image data is sent to the selector 15.

Based on the discrimination result information 23, the controller 20 sends the selector 15 an instruction to send the segmented image data to the image correcting unit 16 or the selector 17, and the selector 15 sends the segmented image data to the image correcting unit 16 or the selector 17 based on the instruction.

When the segmented image data is sent to the image correcting unit 16, the unit 16 sets the conditions for image correction according to the color distribution of segmented image data based on the luminance histogram and the compression ratio R of the segmented image data as mentioned above, and executes image correction (color balance correction, contrast correction, and chroma correction) for the segmented image data. The segmented image data after image correction is then sent to the selector 17.

The selector 17 puts together the segmented image data, not undergone image correction and sent from the selector 13 and/or the selector 15 and/or the segmented image data undergone image correction and sent from the image correcting unit 16, and sends the resultant data as one screen of image data to the color converting unit 18.

The image data sent is subjected to well-known RGB to CMYK color conversion in the color converting unit 18, and is output from the printer 19 as CMYK data.

FIG. 7 is an example of a laser beam printer (LBP) to which the structure of the fixing unit of the image processing apparatus according to one embodiment of the present invention is suitably adapted. FIG. 7 is a cross-sectional view of a LBP to which one embodiment of the present invention is adaptable. Of the structure shown in FIG. 1, the detailed structure of the printer 19 is shown in FIG. 7, and the other structure (the structure from the scanner 10 to the color converting unit 18) is not shown.

Printers that adapt to one embodiment of the present invention are not necessarily limited to LBPs, and other types of printers are also adaptable.

In FIG. 7, an LBP body 1500 receives and stores print information (character codes or the like) and form information or a macro command or the like supplied from a host computer externally connected, generates a character pattern and a form pattern or the like corresponding to those pieces of information, and forms an image on a recording sheet that is a recording medium. An operation panel 1501 has switches for various operations, LED indicators, etc. A printer control unit 1000 performs the general control of the LBP body 1500 and analyzes character information, etc. supplied from the host computer.

The printer control unit 1000 mainly converts character information to a video signal of a character pattern and sends the video signal to a laser driver 1502. The laser driver 1502 drives a semiconductor laser 1503 and turns on or off a laser beam 1504, emitted from the semiconductor laser 1503, according to the input video signal. The laser beam 1504 is swung left and right by a rotary polygon mirror 1505 to scan on and expose an electrostatic drum 1506. Accordingly, the latent image of the character pattern is formed on the electrostatic drum 1506. The latent image is developed by a developing unit 1507 arranged around the electrostatic drum 1506, and is then transferred onto a recording sheet. A cut sheet is used as the recording sheet, and the cut sheet recording sheet is retained in a sheet cassette 1508 mounted in the LBP body 1500, and is fed inside the printer by a sheet feed roller 1509 and transfer rollers 1510 and 1511 to be supplied to the electrostatic drum 1506.

The LBP body 1500 has at least one card slot (not shown) that allows an option font card for other fonts than are initially installed in the printer and a control card of a different language (emulation card) to be connected to the LBP body 1500.

Examples of embodiments of the present invention are described below. However, the present invention is not limited to these embodiments.

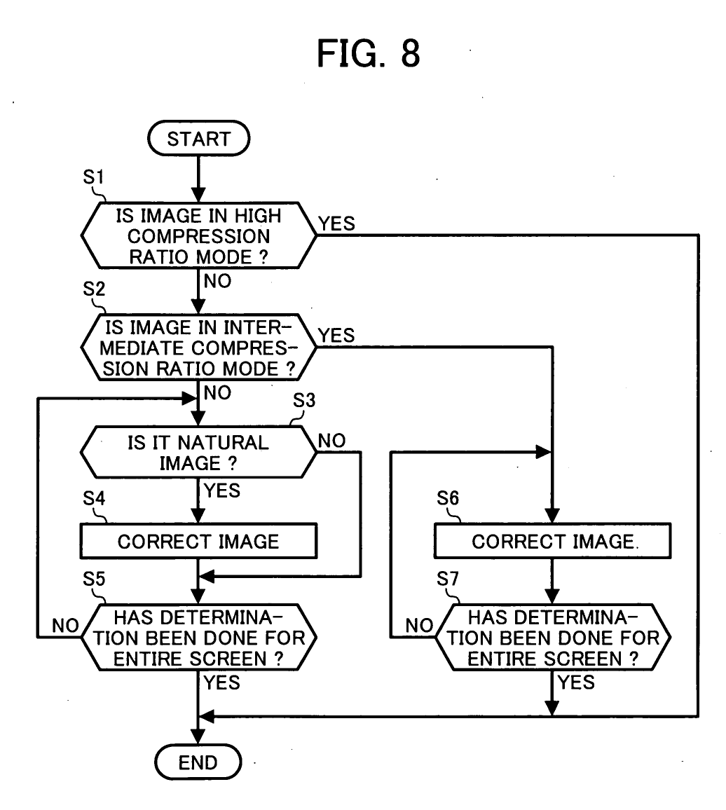

FIG. 8 is a flowchart of the image processing method employed in the controller 20 of the image processing apparatus according to one embodiment of the present invention. The image processing method may be stored in the form of a program in a hard disk in the controller 20 or in a recording medium accessible by the controller 20.

First, it is determined in S1 whether the input image of image data expanded by the expanding unit 12 is in a high compression ratio (R<1/12(R1)) mode based on the compression ratio information 22 for each predetermined area (e.g., 16 pixels×16 pixels) (segmented image data). When the image data is in the high compression ratio mode, the flow is terminated without discriminating the type of the image data or executing image correction, and the image data is sent via the selector 17 to the color converting unit 18 for RGB to CMYK color conversion, and is output from the printer 19 as CMYK data.

This is because when the compression ratio is high, compression-originated deterioration of the image quality is significant regardless of the image type, it is better that the processing speed precedes an improvement on the image quality achieved by image correction.

When the image data is not in the high compression ratio mode, the flow goes to S2 to determine if the mode is an intermediate compression ratio mode.

When the image data is in the intermediate compression ratio ((R1)1/12<R<(R2)1/8) mode, the type of image data is not discriminated and is subjected to predetermined image correction (image correcting unit 16) in S6. It is then determined in S7 whether image correction for the entire screen is finished. When the image correction is finished, the flow is terminated and the corrected image data is sent via the selector 17 to the color converting unit 18 for RGB to CMYK color conversion, and is output from the printer 19 as CMYK data. When the image correction is not finished, on the other hand, the flow returns to S6 to execute image correction.

When the compression ratio is the intermediate ratio, image correction, if executed, improves the image quality of a natural image. If a character/dot image with the intermediate compression ratio is output as it is, deterioration of the image quality, such as color change, may occur. Therefore, deterioration of the image quality, such as color change, is reduced by executing image correction.

When the image data is not in the intermediate compression ratio mode, i.e., when the image data is in a low compression ratio ((R3)1/4<R) mode, the flow goes to S3 to determine whether the type of the image data is a natural image or a character/dot image (for example, Japanese Patent Application Laid-Open No. 2000-295468). When the discrimination result information 23 indicates a natural image, the flow goes to S4 to execute image correction (image correcting unit 16) after which the flow advances to S5.

In executing image correction, the luminance histogram of the input image data is generated and conditions for image correction according to the color distribution of the image data are set based on the histogram and the compression ratio R.

When the discrimination result information 23 does not indicate a natural image in S3, i.e., when the image data is a character/dot image, the flow goes directly to S5 to determine if discrimination is finished for the entire screen. If the discrimination is not finished, the flow returns to S3 to determine if image data is a natural image for another area (16 pixels×16 pixels).

When discrimination for the entire screen is finished in S5, on the other hand, the flow is terminated and the image data is sent via the selector 17 to the color converting unit 18 for RGB to CMYK color conversion, and is output from the printer 19 as CMYK data.

When the compression ratio is low, it is necessary to give priority to the image quality, so that image correction is performed only on a natural image, thereby improving the image quality.

The controller 20 need not determine whether to perform image correction based on a preset compression ratio. When compression/expansion is performed for each predetermined area (16 pixels×16 pixels), the controller 20 may hold expanded image data and the compression ratio information 22 for each area (e.g., high compression ratio (1/10>compression ratio R), intermediate compression ratio (1/6≧compression ratio R≧1/10), low compression ratio (compression ratio R≧1/6)) as flag data and may perform the process based on the flag data.

Referring to the flag data for each area, the subsequent processing can be executed as done in the example.

When the discrimination result information 23 on the type of image data is held as flag data, the image type need not be determined but whether to perform image correction should be determined referring to the flag data.

Further, the method can be used when image data is input as an object image. For example, the compression ratio for the entire screen may be used or the compression ratio for each object may be used for the compression ratio information 22. In the latter case, it is possible to determine the type of image data for each object image and determine based on the discrimination result information 23 whether to perform image correction. One example of the discrimination is described below.

It is assumed that one screen of image data includes a plurality of object images each of which holds compression ratio information (e.g., high compression ratio (1/10>compression ratio R), intermediate compression ratio (1/6≧compression ratio R≧1/10), low compression ratio (compression ratio R>1/6)).

At the time of compressing image data, the image data is compressed object by object according to the compression ratio information held for each object image. Each object image is subjected to well-known image compression using DCT conversion for each block. The compressed object image is then expanded.

At the time of printing, the compression ratio modes (high compression ratio, intermediate compression ratio, low compression ratio, etc.) are displayed on the panel display screen of the copying machine or the like, so that user can select the desired compression ratio mode on the display screen for the background image other than the object image. In accordance with the compression ratio mode, well-known image compression is executed block by block using DCT conversion. The compressed object image is then expanded.

The image type discriminating process and image correction process for an object image should be executed as follows.

When the compression ratio information held for one object image is a low compression ratio, for example, the image type discrimination is performed on the expanded data for each predetermined area (e.g., 16 pixels×16 pixels) (segmented image data). That is, it is determined whether the image data is a natural image or a character/dot image.

When the image data is determined as a natural image, the image correction is performed, whereas when the image data is determined as the other type of image (character/dot image), the image correction is not performed. This is because when the compression ratio is low, the image quality should have a priority, so that the image quality is improved by performing only image correction suitable for a natural image.

When the compression ratio information held for one object image indicates an intermediate compression ratio, the image type is not discriminated and image correction is performed for all types of images. This is because when the compression ratio is intermediate, execution of image correction makes the image quality of a natural image higher. If the compression ratio is an intermediate level for a character/dot image, however, deterioration of the image quality, such as color change, may occur. Therefore, execution of image correction can reduce deterioration of the image quality, such as color change.

When the compression ratio information held for one object image indicates a high compression ratio, the image type is not discriminated and no image correction is performed for all types of images. This is because when the compression ratio is high, the image quality deteriorates significantly, regardless of the image type, so that the processing speed should precede an improvement on the image quality achieved by image correction.

With regard to the background image, the image type discrimination process and image correction process should be executed case by case as done in the operation for an object image.

When the mode set for the background image is a low compression ratio, expanded data is subjected to a process of determining the image type for each predetermined area (e.g., 16 pixels×16 pixels) (segmented image data).

When the image type is discriminated as a natural image in the discrimination process, image correction is performed, whereas the image type is discriminated as other than a natural image (i.e., character/dot image), image correction is not performed.

When the set mode is an intermediate compression ratio or a high compression ratio, the image type is not discriminated and image correction is performed every type of image.

After those processes are executed, the object image and background image data are subjected to well-known RGB to CMYK color conversion and are output as CMYK data.

Although the luminance histogram of the input image data is generated and conditions for image correction according to the color distribution of the image data are set based on the histogram and the compression ratio R in this embodiment, the present invention is not limited to this particular case and conditions for image correction according to the color distribution of the image data may be set based only on the histogram.

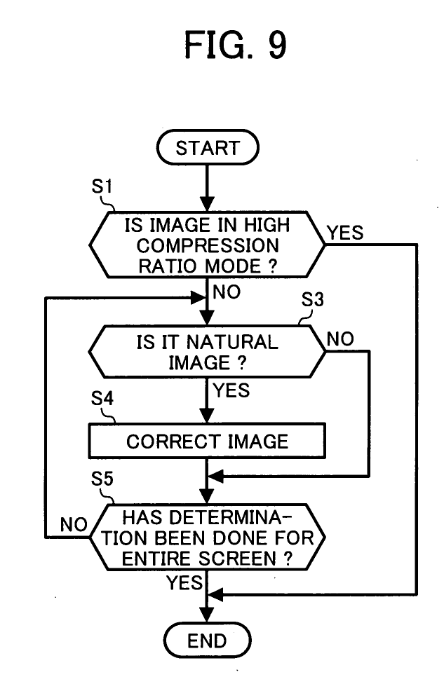

FIG. 9 is a flowchart of one embodiment of an image processing method, which is employed in the controller 20 of the image processing apparatus according to one embodiment of the present invention. As the flowchart does not include the decision on the intermediate compression ratio as involved in the flowchart in FIG. 8, image correction can be performed faster than the previously-described embodiment. The flow will be explained below. As those steps in FIG. 9 that have the same symbols as used in FIG. 8 perform the same processes as described in the foregoing description referring to FIG. 8, their descriptions will be given briefly.

First, it is determined in S I whether the mode is a high compression ratio mode. When it is the high compression ratio mode, the flow is terminated without performing image correction and the image data is sent via the selector 17 to the color converting unit 18 for RGB to CMYK color conversion, and is output from the printer 19 as CMYK data.

When it is not the high compression ratio mode, the flow goes to S3 to determine if the image is a natural image. When the image is a natural image, image correction is performed in S4 after which the flow goes to S5. When the image is not a natural image, on the other hand, the flow goes directly to S5 to determine if processing for the entire screen is finished. When processing for the entire screen is finished, the flow is terminated and the image data is sent via the selector 17 to the color converting unit 18 for RGB to CMYK color conversion, and is output from the printer 19 as CMYK data. When processing for the entire screen is not finished, the flow returns to S3.

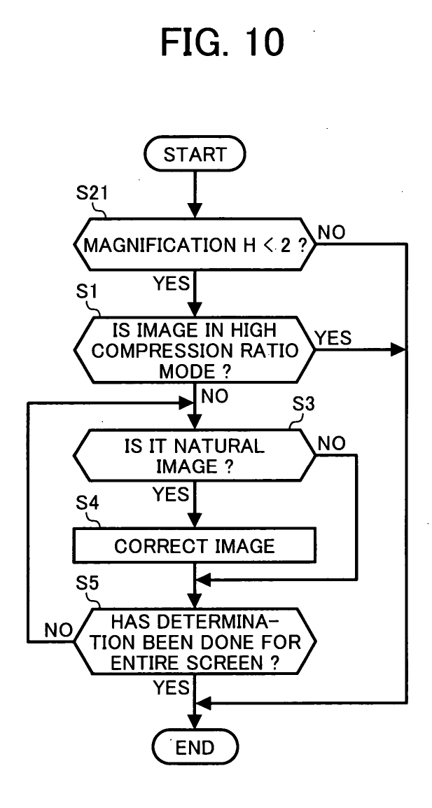

FIG. 10 is a flowchart of one embodiment of an image processing method, which is employed in the controller 20 of the image processing apparatus according to one embodiment of the present invention.

In FIG. 10, the description for the like reference signs in FIG. 8 are simplified, as they are performed like procedure as in FIG. 8.

In this embodiment, a magnification is added as an output condition in the decision on whether to perform image correction in the previously-described embodiment.

First, it is determined in S21 whether the magnification H is smaller than “2.” When H<2, the flow goes to S1 to determine if the mode is a high compression ratio mode. When H≧2, the flow is terminated without performing image correction, and the image data is sent via the selector 17 to the color converting unit 18 for RGB to CMYK color conversion, and is output from the printer 19 as CMYK data. This is because the degree of image thinning is large or the degree of image interpolation is large, showing significant deterioration of the image quality, so that it is effective to select easy processing over a slight improvement on the image quality.

When the mode is a high compression ratio mode in S1, the flow is terminated without performing image correction and the image data is sent via the selector 17 to the color converting unit 18 for RGB to CMYK color conversion, and is output from the printer 19 as CMYK data. This is because compression-originated deterioration is significant, so that it is effective to select easy processing over a slight improvement on the image quality achieved by image correction. When the mode is not a high compression ratio mode in S1, i.e., when the set mode is an intermediate or low compression ratio, the flow goes to S3 to determine the type of the image data expanded by the expanding unit 12 for each predetermined area (16 pixels×16 pixels) (segmented image data).

It is determined in S3 whether the image is a natural image. When the image is a natural image, the flow goes to S5 after performing image correction. When the image is not a natural image (i.e., when it is a character/dot image), the flow goes to S5 without performing image correction. When the compression ratio is intermediate or low, it is necessary to give priority to the image quality, so that image correction is performed only on a natural image for image correction is suitable for a natural image.

When it is determined in S5 whether determination for the entire screen is finished. When determination for the entire screen is finished, the flow is terminated and the image data is sent via the selector 17 to the color converting unit 18 for RGB to CMYK color conversion, and is output from the printer 19 as CMYK data. When the image correction is not finished, on the other hand, the flow returns to S3.

Although the magnification as an output condition is added in the decision on whether to perform image correction in addition to the discrimination of the compression ratio of an input image and the type of the input image in a previously-described embodiment, another output condition, such as resolution, may be added in place of the magnification, or resolution or the like may be added as an output condition in addition to the magnification.

Although image correction is not performed when the magnification H is equal to or greater than “2” in this embodiment, this condition is not of course restrictive.

Although the decision on whether to perform image correction is done by the program stored in the controller 20 in the embodiments described above, this is not restrictive. For example, the program may be retained in a recording medium accessible by the controller 20.

According to one embodiment of the present invention, it is determined whether image correction according to color distribution of the image data should be performed depending on the compression ratio and a type of the image data. It is therefore possible to provide an image processing apparatus that makes a decision on whether to perform image correction with a high precision by a simple method, thereby ensuring a high processing efficiency and a high output image quality.

According to several embodiments of the present invention, the image correction efficiency of an image processing apparatus is increased, thereby providing an image processing apparatus with a high processing efficiency.

According to several embodiments of the present invention, as the resolution or the magnification, which is an output condition, is added in the process of determining whether to perform image correction. Therefore, a decision on whether to perform image correction can be done with a higher precision by a simple method. This makes it possible to provide an image processing apparatus having a high processing efficiency and a high output image quality.

According to further embodiments of the present invention, as image correction is performed using a luminance histogram or the like, an image processing apparatus that makes an output image clearer can be provided.

According to one embodiment of the present invention, it is possible to provide a simple image processing method that makes a decision on whether to perform image correction with a higher precision.

According to one embodiment of the present invention, it is possible to provide an image processing program including an image processing method that makes a decision on whether to perform image correction with a higher precision.

According to one embodiment of the present invention, it is possible to provide a recording medium having an image processing program that makes a decision on whether to perform image correction by a simple method with a higher precision.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. An image processing apparatus comprising:
a compressing unit to compresses image data input by an input unit at a desired compression ratio to generate compressed image data;
a storage unit to store the compressed image data; and
a control unit to read out the compressed image data stored in the storage unit and determine whether image correction according to color distribution of the image data should be performed based on the compression ratio and a type of the image data.

2. The image processing apparatus according to claim 1, wherein when the compression ratio smaller than a predetermined compression ratio, the type of the image data is not discriminated.

3. The image processing apparatus according to claim 2, wherein the image correction is not performed.

4. The image processing apparatus according to claim 1, wherein when the compression ratio is smaller than a first predetermined compression ratio and the first predetermined compression ratio is smaller than a second predetermined compression ratio, the type of the image data is not discriminated.

5. The image processing apparatus according to claim 4, wherein the image correction is not performed.

6. The image processing apparatus according to claim 1, wherein
when the compression ratio is larger than a third predetermined compression ratio, the type of the image data is discriminated, and
the image correction is performed only when the type of the image data is a natural image.

7. The image processing apparatus according to claim 1, wherein when the type of the image data is either of a character and a dot image, the image correction is not performed.

8. The image processing apparatus according to claim 1, wherein an output condition is added in determining whether to perform the image correction.

9. The image processing apparatus according to claim 8, wherein the output condition is a resolution.

10. The image processing apparatus according to claim 8, wherein the output condition is a magnification.

11. The image processing apparatus according to claim 1, further comprising a histogram creating unit to create a luminance histogram of the image data, wherein
conditions for the image correction according to the color distribution of the image data are set based on the luminance histogram.

12. The image processing apparatus according to claim 1, further comprising a histogram creating unit to create a luminance histogram of the image data, wherein
conditions for the image correction according to the color distribution of the image data are set based on the luminance histogram and the compression ratio.

13. An image processing method comprising:
compressing image data input by an input unit at a desired compression ratio to generate compressed image data;
storing the compressed image data;
reading out the compressed image data stored in the storage unit; and
determining whether image correction according to color distribution of the image data should be performed based on the compression ratio and a type of the image data.

14. An article of manufacture having one or more recordable media storing a computer readable program having instructions, which, when executed by a computer, cause the computer to perform a method comprising:
compressing image data input by an input unit at a desired compression ratio to generate compressed image data;
storing the compressed image data;
reading out the compressed image data stored in the storage unit; and
determining whether image correction according to color distribution of the image data should be performed based on the compression ratio and a type of the image data.
